(19) United States
(12) Patent Application Publication
(10) Pub. No.: US 2017/0266591 A1
(43) Pub. Date: Sep. 21, 2017

(54) System and Method for Manufacturing Erosion Control Switchgrass Filter Socks

(71) Applicants: Perry Ray Burt, Cambridge, OH (US); James Elkin, Shelocta, PA (US); Joseph O. Greco, Atlantic, PA (US)

(72) Inventors: Perry Ray Burt, Cambridge, OH (US); James Elkin, Shelocta, PA (US); Joseph O. Greco, Atlantic, PA (US)

(21) Appl. No.: 15/616,838

(22) Filed: Jun. 7, 2017

Related U.S. Application Data
(63) Continuation-in-part of application No. 14/692,056, filed on Apr. 21, 2015.
Application No. 14/692,056 is a continuation-in-part of application No. 15/585,126, filed on May 2, 2017.
(60) Provisional application No. 62/346,972, filed on Jun. 7, 2016.
(60) Provisional application No. 61/982,596, filed on Apr. 22, 2014.
(60) Provisional application No. 62/330,679, filed on May 2, 2016.

(51) Int. Cl. B01D 29/11; B65B 63/00; B65B 39/00; B65B 53/00

(52) U.S. Cl. CPC B01D 29/111; B65B 53/00; B65B 63/00; B65B 39/00

(57) ABSTRACT

A system and method for manufacturing erosion control filter socks consists of a mass of filtering material, a material supply assembly, an assembly section, and a packaging section. Switchgrass is used as the filtering material. Upon receiving the mass of filtering material, the material supply assembly appropriately transfers the filtering material to the assembly section. The filtering material is loaded into a receiving sock with the use of a sizing funnel in the assembly section to create a filter sock. The density of the filtering material within the filter sock varies. When loading is complete, the packaging section sizes the filter sock accordingly. When sizing the filter sock is complete, the filter sock is wrapped in a plastic cover so that the filter sock can be conveniently transported and installed.

The current application claims a priority to the U.S. Provisional Patent application Ser. No. 62/346,972 filed on Jun. 7, 2016.

### FIELD OF THE INVENTION

The present invention relates generally to erosion control. More specifically, the present invention introduces a method of creating a filtration sock that uses switchgrass as the filtering material.

### BACKGROUND OF THE INVENTION

Different methods are being used for erosion control. Planting grass and shrubs, adding mulch or rocks, using mulch matting, laying out fiber logs, filtration socks, and retainer walls are some of the most common methods for erosion control. Even though these methods have significant benefits, there are certain drawbacks that need to be addressed.

The present invention is related to filtration socks. More specifically, the present invention introduces a process of manufacturing a filtration sock that utilizes switchgrass as the filtering material. Compared to other filtering material used in filtration socks, such as compost or vegetation, switchgrass is known to have better filtering properties.

A majority of existing filtration socks need to be prepared and installed at the site. Such an approach can be labor intensive and time consuming. When installing the filtration socks at a very large scale, being labor intensive and time consuming can be disadvantageous in terms of profitability.

Filling the filtration sock with the filtering material on site can also be problematic. As an example, if the terrain in which the filtration sock is to be installed is uneven, moving and handling the machinery at the site can be stressful. Considering all these facts, the need for a method that is efficient and effective is clear.

The objective of the present invention is to address the aforementioned issues. In particular, the present invention introduces a method that can be used to create a more efficient filtration sock. Compared to existing filtration socks, the present invention can be installed much more conveniently. By utilizing the present invention, the overall efficiency and profitability is improved.

### BRIEF DESCRIPTION OF THE DRAWINGS

FIG. 1A is a top view illustrating the present invention.

FIG. 1B is a block diagram illustrating the present invention.

FIG. 2 is a block diagram illustrating the material supply assembly.

FIG. 3A is a block diagram illustrating the assembly section.

FIG. 3B is another illustration of the assembly section.

FIG. 4 is a block diagram illustrating the packaging section.

FIG. 5 is a flowchart illustrating the basic overall process of the present invention.

FIG. 6 is a perspective view of the filter sock, wherein the filter sock is of predetermined length.

### DETAIL DESCRIPTIONS OF THE INVENTION

All illustrations of the drawings are for the purpose of describing selected versions of the present invention and are not intended to limit the scope of the present invention.

The present invention introduces a system and a method of manufacturing erosion control filter socks. By utilizing the system and the method introduced by the present invention, the user can manufacture and install erosion control filter socks that are convenient and effective.

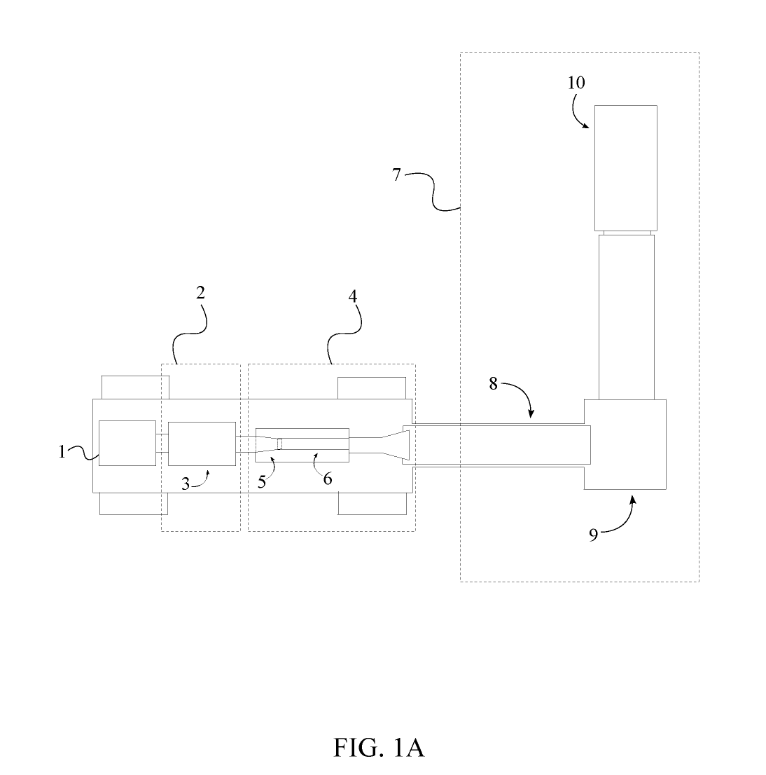

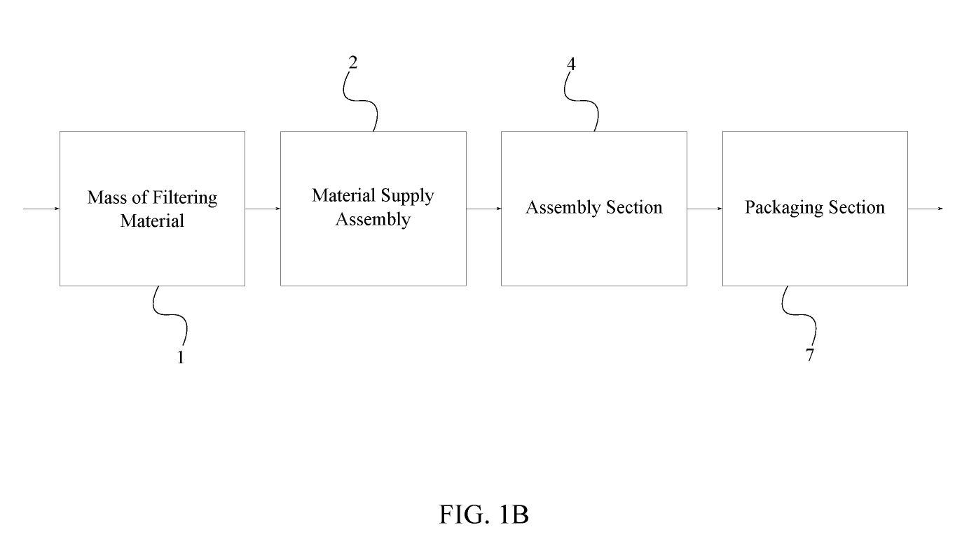

As illustrated in FIG. 1A and FIG. 1B, the system for manufacturing erosion control filter socks comprises a mass of filtering material 1, a material supply assembly 2, an assembly section 4, and a packaging section 7. When the present invention is being used in the field, the mass of filtering material 1 is used to retain sediments and other pollutants such as suspended solids, tannic acids, nitrates, phosphates, motor oil and other comparable pollutants. In the preferred embodiment of the present invention, switchgrass is used as the mass of filtering material 1. As a result, any impurity including low level radiation which is filtered by switchgrass can be removed when the present invention is in use. The material supply assembly 2 of the system ensures that the mass of filtering material 1 is provided appropriately for the manufacturing process. When the material supply assembly 2 provides the mass of filtering material 1, the assembly section 4 proceeds to process the mass of filtering material 1. When processed at the assembly section 4, the packaging section 7 completes the actions needed for installing and transporting a filter sock 50 used for erosion control.

The material supply assembly 2, the assembly section 4, and the packaging section 7 are appropriately configured to execute the process of manufacturing the filter sock 50. More specifically, the material supply assembly 2 is configured to receive the mass of filtering material 1 and output the mass of filtering material 1 into the assembly section 4. The speed and volume in which the mass of filtering material 1 is transferred to the assembly section 4 is determined by the material supply assembly 2. When transferring is complete, the mass of filtering material 1 is received at the assembly section 4. To do so, the assembly section 4 is configured to receive the mass of filtering material 1 and assemble the mass of filtering material 1 into the filter sock 50. To prepare the filter sock 50 for transportation and installation, the packaging section 7 is configured to receive the filter sock 50 from the assembly section 4.

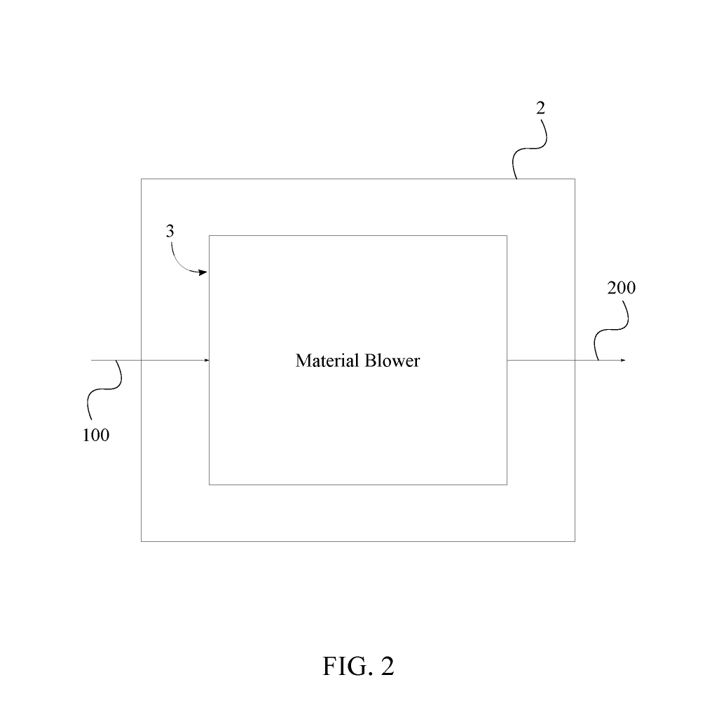

As shown in FIG. 2, in the preferred embodiment of the present invention, to transfer the mass of filtering material 1 to the assembly section 4, the material supply assembly 2 comprises a material blower 3 that is configured to receive the mass of filtering material 1. Thus, when the mass of filtering material 1 is provided, the material blower 3 transfers the mass of filtering material 1 to the assembly section 4 at a speed and volume determined by the user.

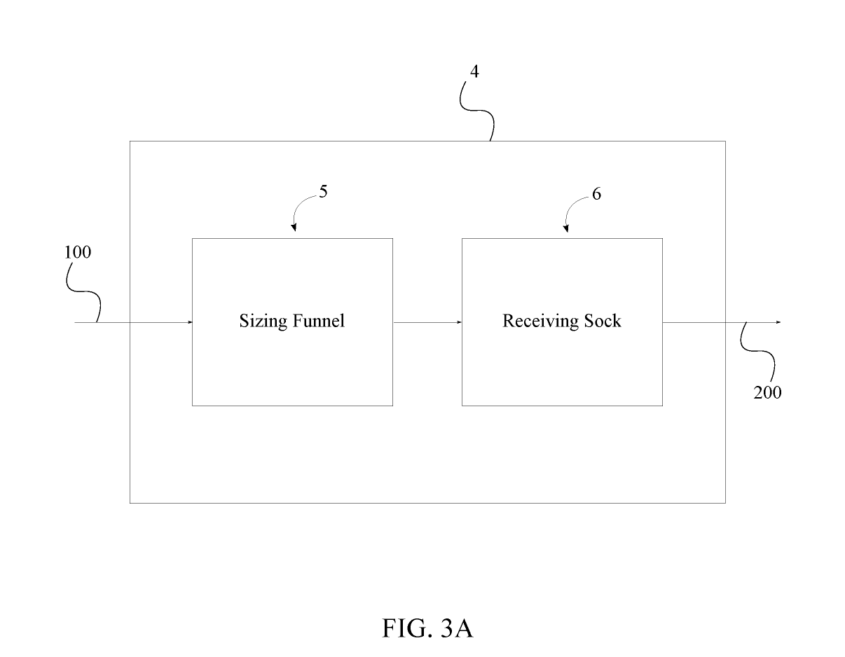

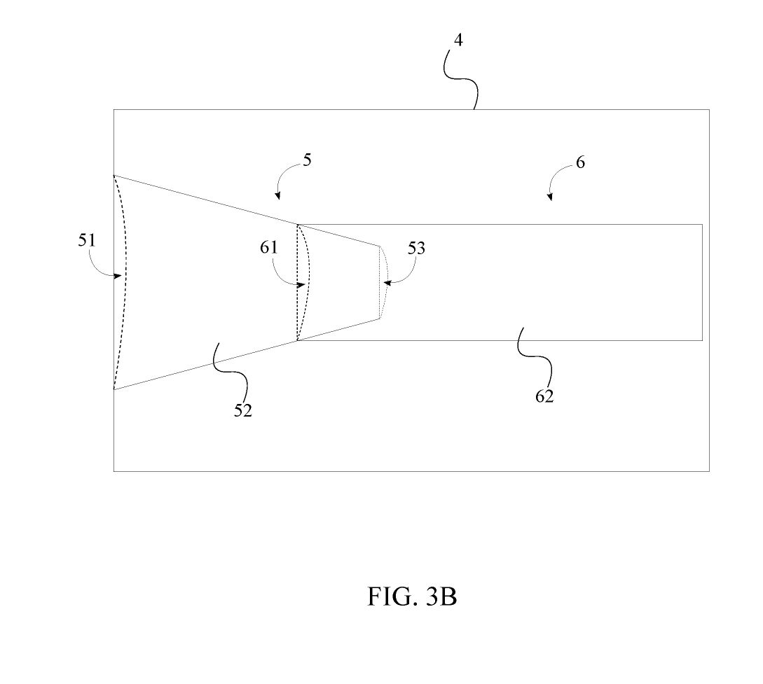

As seen in FIG. 3A and FIG. 3B, to receive the mass of filtering material 1 and execute the assembling process, the assembly section 4 comprises a sizing funnel 5 and a receiving sock 6. The sizing funnel 5, which can vary in size in different embodiments of the present invention, determines the diameter of the filter sock 50. The receiving sock 6 functions as a sleeve that is used for storing the mass of filtering material 1 and is used to create the filter sock 50 as an end product. Preferably, the receiving sock 6 is made of a biodegradable mesh that is water permeable. For the sizing funnel 5 to work in conjunction with the receiving sock 6, the sizing funnel 5 comprises a proximal opening 51, a funnel body 52, and a distal opening 53. The proximal opening 51 and the distal opening 53 are positioned opposite to each other across the funnel body 52 and traverse into the funnel body 52. Moreover, the proximal opening 51 is configured to receive the mass of filtering material 1. Therefore, the mass of filtering material 1 that enters at the proximal opening 51 passes through the funnel body 52 and exits at the distal opening 53.

The mass of filtering material 1 exiting the funnel body 52 advances to the receiving sock 6. To do so, the receiving sock 6 comprises a sock body 62 and a sock opening 61 which terminally traverses into the sock body 62. For efficient transferring of the mass of filtering material 1, the sock opening 61 is perimetrically connected adjacent to the distal opening 53. The mass of filtering material 1 is stacked into the receiving sock 6 to a preferred density. The density of the mass of filtering material 1 within the receiving sock 6 can vary among different embodiments of the present invention.

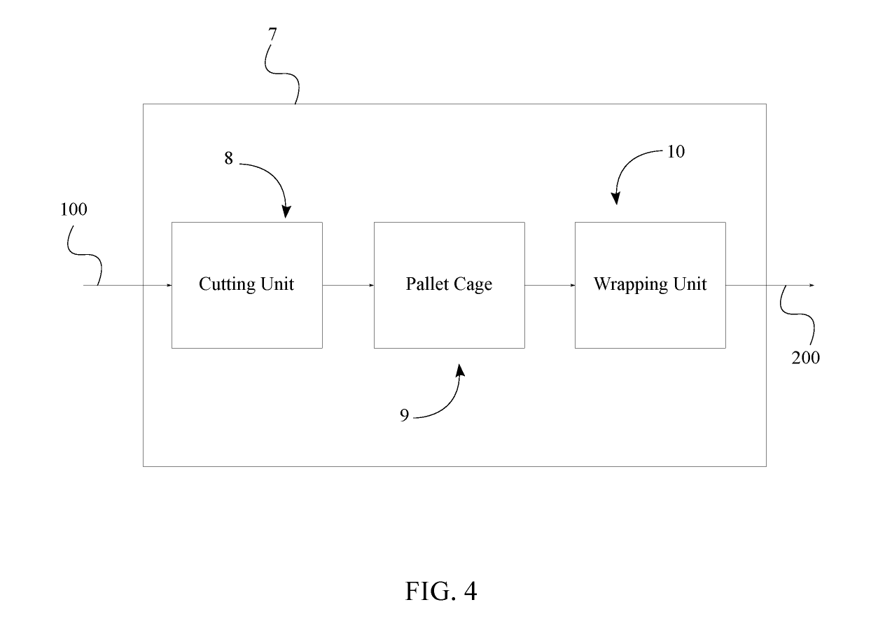

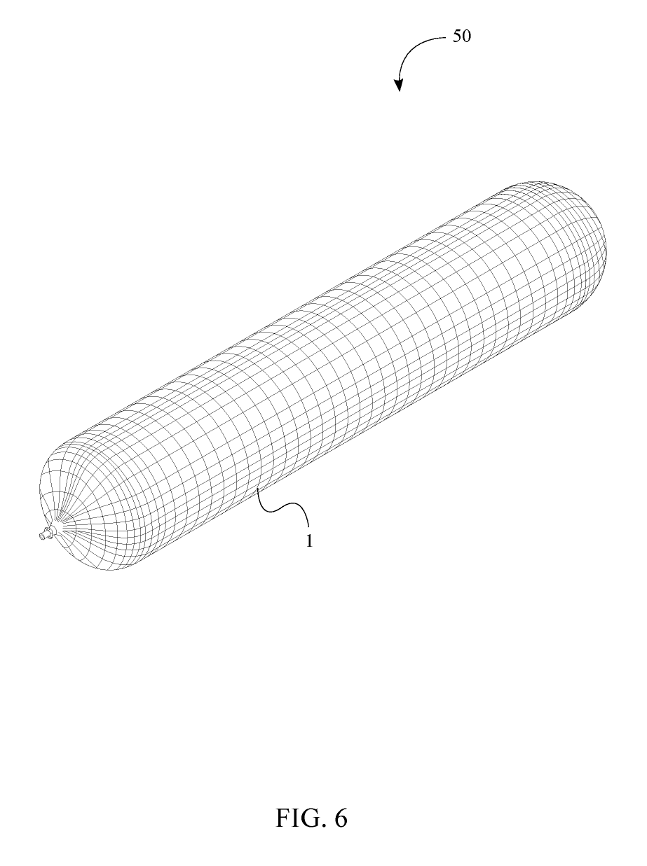

When the receiving sock 6 is loaded with the mass of filtering material 1, the receiving sock 6 is transferred to the packaging section 7 as the filter sock 50. As seen in FIG. 4, to prepare the filter sock 50 for transporting and installing, the packaging section 7 comprises a cutting unit 8, a pallet cage 9, and a wrapping unit 10. The cutting unit 8, which is configured to receive the filter sock 50 from the assembly section 4, allows the user to size the filter sock 50 into a preferred length. The preferred length of the filter sock 50 can vary according to the location and the need. As illustrated in FIG. 6, when sized appropriately, the receiving sock 6 is secured around the mass of filtering material 1 positioned within the receiving sock 6. The pallet cage 9 is configured to transfer the filter sock 50 to the wrapping unit 10. In the pallet cage 9, the filter sock 50 is arranged into a shape determined by the user. More specifically, the pallet cage 9 allows the user to rearrange the shape of the filter sock 50 for storing purposes. Upon receiving the filter sock 50, the wrapping unit 10 outputs the filter sock 50 for transportation and installation. In the preferred embodiment of the present invention, the wrapping unit 10 places a plastic cover over the filter sock 50 and shrink wraps the filter sock 50. However, super sacks or other comparable methods can be used in other embodiments of the present invention so that the filter sock 50 can be conveniently transported.

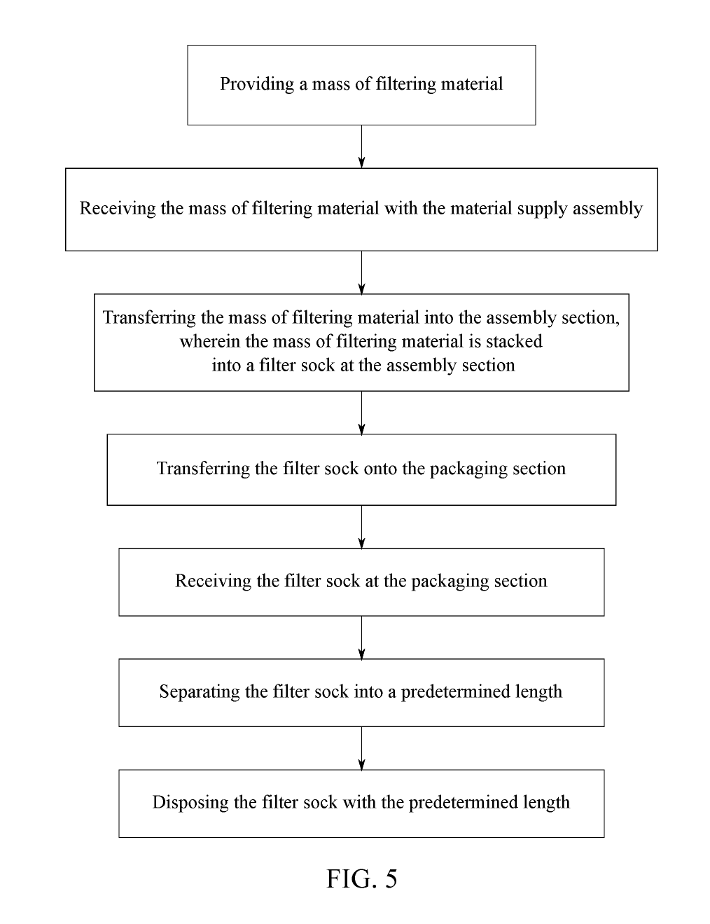

As illustrated in FIG. 5, when considering the method of implementing the system of manufacturing the erosion control filter sock 50, the following process flow is generally followed. Initially, the mass of filtering material 1, which is switchgrass in the preferred embodiment of the present invention, is provided. The mass of filtering material 1 is then received by the material supply assembly 2 through an inlet 100. Upon receiving, the mass of filtering material 1 is transferred into the assembly section 4 through an outlet 200 of the material supply assembly 2. When transferred, the mass of filtering material 1 is loaded to create the filter sock 50 at the assembly section 4. To be stacked into the filter sock 50, the mass of filtering material 1 is transferred to the receiving sock 6 via the sizing funnel 5. The receiving sock 6 is then transferred to the packaging section 7 as the filter sock 50 through an outlet 200 of the assembly section 4. At the packaging section 7, the filter sock 50 is received through an inlet 100 of the packaging section 7. Upon receiving the filter sock 50 at the packaging section 7, the filter sock 50 is separated into a predetermined length. In the preferred embodiment, separating the filter sock 50 to the predetermined length is done via the cutting unit 8. However, separating the filter sock 50 to the predetermined length can also be completed manually in another embodiment of the present invention. After separating the filter sock 50 according to the predetermined length, the filter sock 50 is wrapped in a protective cover and disposed through an outlet 200 of the packaging section 7.

Although the invention has been explained in relation to its preferred embodiment, it is to be understood that many other possible modifications and variations can be made without departing from the spirit and scope of the invention as hereinafter claimed.

What is claimed is:

1. A system for manufacturing erosion control filter sock comprises:
a mass of filtering material;
a material supply assembly;
an assembly section;
a packaging section;
the material supply assembly being configured to receive the mass of filtering material and output the mass of filtering material into the assembly section;
the assembly section being configured to receive the mass of filtering material and assemble the mass of filtering material into a filter sock; and
the packaging section being configured to receive the filter sock.

2. The system for manufacturing erosion control filter socks as claimed in claim 1, wherein the mass of filtering material is switchgrass.

3. The system for manufacturing erosion control filter socks as claimed in claim 1 further comprises:
the material supply assembly comprises a material blower; and
the material blower being configured to receive the mass of filtering material.

4. The system for manufacturing erosion control filter socks as claimed in claim 1 further comprises:
the assembly section comprises a sizing funnel and a receiving sock;
the sizing funnel comprises a proximal opening, a funnel body, and a distal opening;
the proximal opening and the distal opening being positioned opposite to each other across the funnel body and traversing into the funnel body;
the receiving sock comprises a sock opening and a sock body;
the sock opening terminally traversing into the sock body;
the proximal opening being configured to receive the mass of filtering material; and
the sock opening being perimetrically connected adjacent to the distal opening.

5. The system for manufacturing erosion control filter socks as claimed in claim 1 further comprises:
the packaging section comprises a cutting unit, a pallet cage, and a wrapping unit;
the cutting unit being configured to receive the filter sock;
the pallet cage being configured to transfer the filter sock to the wrapping unit; and
the wrapping unit being configured to output the filter sock.

6. A method of implementing the system of manufacturing erosion control filter socks as claimed in claim 1 comprises the steps of:
providing a mass of filtering material;
receiving the mass of filtering material with the material supply assembly;
transferring the mass of filtering material into the assembly section, wherein the mass of filtering material is stacked into a filter sock at the assembly section;
transferring the filter sock onto the packaging section;
receiving the filter sock at the packaging section;
separating the filter sock into a predetermined length; and
disposing the filter sock with the predetermined length.

7. The method of implementing the system of manufacturing erosion control filter socks as claimed in claim 6, wherein the mass of filtering material is transferred through an outlet of the material supply assembly.

8. The method of implementing the system of manufacturing erosion control filter socks as claimed in claim 6, wherein the filter sock is transferred to the packaging section through an outlet of the assembly section.

9. The method of implementing the system of manufacturing erosion control filter socks as claimed in claim 6, wherein the filter sock is received through an inlet of the packaging section.

10. The method of implementing the system of manufacturing erosion control filter socks as claimed in claim 6, wherein the filter sock is disposed through an outlet of the packaging section.

11. The method of implementing the system of manufacturing erosion control filter socks as claimed in claim 6, wherein the mass of filtering material is switchgrass.

12. The method of implementing the system of manufacturing erosion control filter socks as claimed in claim 6 further comprises the steps of:
providing a sizing funnel and a receiving sock for the assembly section; and
transferring the mass of filtering material to the receiving sock via the sizing funnel.

13. The method of implementing the system of manufacturing erosion control filter socks as claimed in claim 6, wherein the filtering sock is separated to the predetermined length manually.

14. The method of implementing the system of manufacturing erosion control filter socks as claimed in claim 6, wherein the filtering sock of predetermined length is wrapped in a protective cover.
